(19) United States
(12) Patent Application Publication
(10) Pub. No.: US 2021/0027646 A1
(43) Pub. Date: Jan. 28, 2021

(54) Incentive methods and systems for educational game software on mobile platform

(71) Applicant: Yuefei Su, Palo Alto, CA (US)

(72) Inventor: Yuefei Su, Palo Alto, CA (US)

(21) Appl. No.: 16/521,305

(22) Filed: Jul. 24, 2019

(51) Int. Cl. G09B 7/00

(52) U.S. Cl. CPC G09B 7/00

(57) ABSTRACT

Aspects of the present disclosure are presented for methods and systems that can be used in mobile education game software for inspiring and maintaining users' interest of study, improving experience of mobile learning game software, promoting improvement of learning method, and improving usage completion rate of educational game software. Embodiment of the invention show five major aspects of methods and systems, that can motivate education game user. The five major aspects include six results feedback excitation methods/systems, two personal target reminding methods/systems, two training process positive encouragement methods/systems, one learning achievement sharing and showing method/system, one learning achievement saving and printing method/system.

### FIELD OF THE INVENTION

The invention relates to methods and systems for motivating user to learn more effectively in mobile educational game software.

### BACKGROUND OF THE INVENTION

A variety of products based on mobile education media emerge in an endless stream, that is, the educational apps has a wide variety of styles. However, in the actual application process, many students are halfway through the use of educational apps after a period of time of use. Compared with traditional learning methods and entertainment games, the usage completion rate of educational apps is very low. It is very urgent to improve the motivation of educational game software, and to strengthen the design of learning incentive system.

How to use educational technology, game mechanics, psychological principles, big data analysis, curriculum design and other incentives to improve the learning completion rate of educational apps, improve learning motivation, stimulate learning interest, and let students like learning just as playing games is the fundamental task of this invention. And the methods/systems can be quickly applied to all educational apps' design.

### BRIEF SUMMARY OF THE INVENTION

This invention include methods and systems that relate to mobile educational game software, make learning more interesting, motivate users to focus on, and keep on learning.

The embodiment of the invention may be deployed on the client end and service end operating environment respectively, wherein the client end operating environment may be a mobile device, such as a mobile phone, pocket PC, the service end operating environment may be a cloud storage service, acting as a backstage support system.

The first major part of this invention includes six results feedback incentives methods/systems, comprising Growth Path, Learning Role Models, My Prize, My Honor, My Transcript, My Ranking methods/systems. These six external incentives methods and systems are closely related to internal incentives, including the inner expectations and sense of honor of academic progress. The six results feedback excitation methods/systems can be implemented in mobile educational game individually or jointly, but using jointly is the core of achieving the best incentive effect.

The second major part of this invention includes two personal learning target reminding methods/systems, comprising Learning Goal Prompt, Learning Ranking Reminder. These personal learning target reminding methods/systems can be implemented in mobile educational game individually or jointly, which allows users to keep abreast of learning progress and achievements in a timely and effective manner, thus stimulate users' motivation and interesting in study.

The third major part of this invention includes training process positive encouragement methods/systems, comprising Adding Points for Answering Question Correctly; Sound Effects, Pictures, Colorful Presentation for Answering Question Correctly. Compared with six results feedback incentives methods/systems, these two positive encouragement are implemented in process where users might lose focus on learning little by little. Many researches and experiences have proved that continuous and positive encouragement in learning process play a great role in studying.

The forth major part of this invention includes one Achievement Sharing and Showing method/system. Achievement Sharing and Showing can inspire a sense of honor to individuals, form a benign competition in groups.

The fifth major part of this invention includes one learning achievement saving and printing method/system. Through this method/system, users can record every milestone of studying, export achievement information that, for example, can be used in a competition and/or commendation activity.

To describe the methods and systems of this invention, an educational app, named ‘I Am Li Bai: The Most Valuable Ancient Poetry Learning Game’, hereinafter referred to as I Am Li Bai, is presented as an example.

The above simplified summary of this invention serves to provide a basic understanding of the present disclosure. This summary is not an extensive overview of all contemplated aspects, and is intended to neither identify key or critical elements of all aspects nor delineate the scope of any or all aspects of the present disclosure.

### BRIEF DESCRIPTION OF THE DRAWINGS

FIG. 1 shows application scenario of the example educational game software.

FIG. 2 shows composition chart of methods and systems of this invention.

FIG. 3 shows application assumptions of the methods and systems of this invention in educational game software.

FIGS. 4A,B shows two kinds of schematic diagram of the main interface of the educational game software integrating the incentive methods or systems of this invention.

FIGS. 5A,B show cartoon images of characters of the example educational game software, which are used in an embodiment of the Growth Path method and system of this invention.

FIG. 6 show the main interface of the example educational game software integrating embodiment of the incentive methods or systems of this invention.

FIG. 7 shows the virtual prizes of the example educational game software, which are used in an embodiment of My Prize method and system of this invention.

FIG. 8 shows the certificate picture of the example educational game software, which is used in an embodiment of My Honor method and system of this invention.

FIGS. 9A,B show the transcript interface of the example educational game software, which is used in an embodiment of My Transcript method and system of this invention.

FIG. 10 shows the ranking interface of the example educational game software, which is used in an embodiment of My Ranking method and system of this invention.

FIG. 11A shows the praise sentences corresponding to number of questions completed of the example educational game software, which are used in an embodiment of Sound, Effects, Pictures, Colorful Presentation for Answering Question Correctly method and system of this invention.

FIG. 11B shows the pictures of the example educational game software, which are used in an embodiment of Sound, Effects, Pictures, Colorful Presentation for Answering Question Correctly method and system of this invention.

FIGS. 11C-D shows the sound effect, illustrations, scenes corresponding to time point of the example educational game software, which are used in an embodiment of Sound, Effects, Pictures, Colorful Presentation for Answering Question Correctly method and system of this invention.

FIG. 12 shows the interface of the example educational game software, which is used in an embodiment of Achievement Sharing and Showing method/system of this invention.

### DETAILED DESCRIPTION OF THE INVENTION

Those of ordinary skill in the art will realize that the following description is illustrative only and is not intended to be in any way limiting. Other aspects will readily suggest themselves to those skilled in the art having the benefit of this disclosure.

### Application Scenario

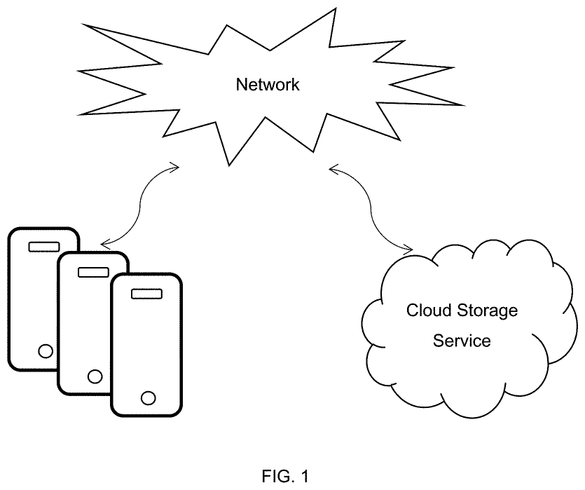

As shown in FIG. 1, this invention includes a set of methods and systems of educational game software which can be applied on mobile devices, such as mobile phones, pad, pocket PC. Users will use the educational game software on their respective mobile device, which are connected through network. To share, rank achievements in a group, there should be a software function providing services of data storage, analysis, which can be called Server End Software Functional Composition, and be deployed on a cloud storage service.

### The Origin of the Invention

Study is a important thing to individual, family, and society too. And, in common sense, to succeed in study needs hard work for a long time, so it isn't funny thing for most people. To find some way that can make studying more interesting, more efficient, people naturally think about game software which can make child and adult ‘lost’ in it for many hours, even days.

There are two opposite/different opinions, that one believes technology, method for designing game should be implemented and integrated into educational software in-depth; the other one believes there is basic contraction between game and study, so combining game and study can get limited success. The debate about game and study would continue, but it's worth exploring how to make study/study software more attractive.

Learning motivation can classed into two groups, Intrinsic and External. Intrinsic motivation refers to the motivation that the study itself brings, including the interest of the study itself, the sense of responsibility, and the sense of accomplishment. External incentives refer to excitation outside of study, including increased rewards, promotion of ranking, and so on. In contrast, intrinsic motivation has a more stable, longer lasting, and more intense effect.

Intrinsic incentives and external incentives differ in characteristics, effects, and methods of use. In order to rationally design external incentive methods, consideration must be taken to understand the mechanism of internal and external incentives.

Based on such thought, and years of mobile educational software designing practice and experience, we find a set of methods that can and should be applied jointly in educational software to attractive user, and improve learning completion rate, though these methods and systems can be applied individually to give a certain degree of incentive. And these methods make full use of multimedia means, such as sound and animation to make the educational software attractive.

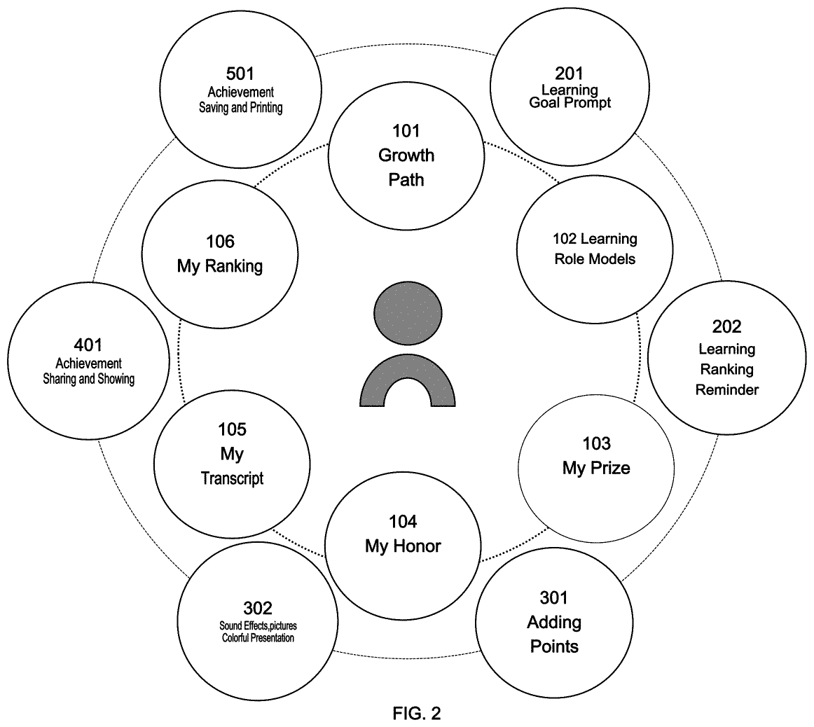

The disclosure of the invention includes five major aspects of methods and systems, that can motivate education game software user. The five major aspects include six Results Feedback Excitation methods/systems, 101 to 106; two Personal Target Reminding methods/systems, 201 to 202; two Training Process Positive Encouragement methods/systems, 301 to 302; one Learning Achievement Sharing and Showing method/system 401, and one Learning Achievement Saving and Printing method/system 501, as shown in FIG. 2.

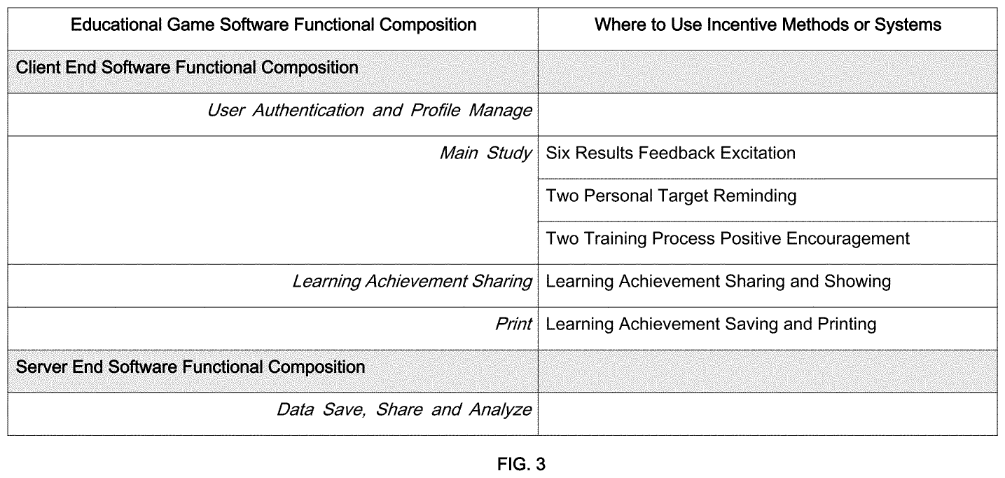

FIG. 3 shows functional composition of a common educational game software, and which functional module the methods and systems of the invention can be used for. That is, six Results Feedback Excitation, two Persona Target Reminding, two Training Process Positive Encouragement methods and systems can be used in main study module design; Learning Achievement Sharing and Showing method and system can be used in learning achievement sharing module design; Learning Achievement Saving and Printing can be used in print module design.

### Results Feedback Excitation Methods and Systems

FIG. 2 shows the six major results feedback incentives methods/systems implemented in the embodiment of this invention, comprising 101 Growth Path, 102 Learning Role Models, 103 My Prize, 104 My Honor, 105 My Transcript, 106 My Ranking. These six external incentives are closely related to internal incentives, including the inner expectations and sense of honor of academic progress.

These results feedback incentives methods/systems can be implemented in mobile educational game software individually or jointly, but this invention testify and emphasize that JOINT use of these six incentive method is more effective. Joint and centralized use can present achievement and learning status more directly and comprehensively, so can provide more motivation to user's senses, thereby inspire more strong desire to learn. Although the joint use of these six incentive methods could be effective to most users, to provide more flexibility, the embodiment of the invention could allow users to “turn on/off” one or more of incentives to their liking.

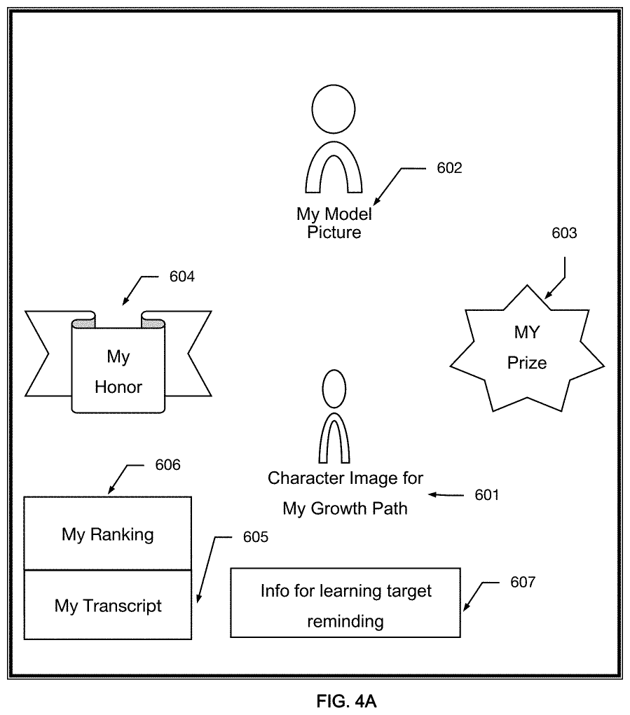

As shown in FIG. 4A, which is the schematic of main interface of example software, I Am Li Bai, the six factor corresponding to the six results feedback excitation methods and systems are integrated into the same main graphic interface. That is, interface component 601 corresponds to 101 Growth Path, 602 corresponds to 102 Learning Role Models, 603 corresponds to 103 My Prize, 604 corresponds to 104 My Honor, 605 corresponds to 105 My Transcript, 606 corresponds to 106 My Ranking, respectively.

As shown in FIG. 4B, which is another kind of schematic of main interface of educational game software, the six factor corresponding to the six results feedback excitation methods and systems are integrated into the main graphic interface too.

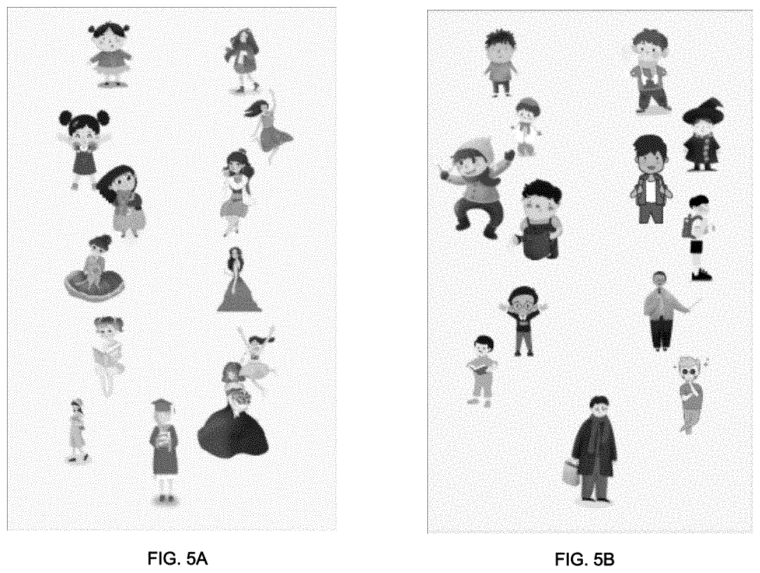

In example App, I Am Li Bai, after the user completes authentication and login operation, the main interface, as shown in FIG. 6, will be presented to users, where the user can be prompted information regarding 101 Growth Path, 102 Learning Role Models, 103 My Prize, 104 My Honor, 105 My Transcript, 106 My Ranking shown through pictures and/or words. In this way, the user can intuitively and comprehensively understand the learning state, thereby being motivated to continue learning. Usually, there are many educational software which only involve several of the above methods, and don't directly display the related information on the main interface.

### Growth Path

The function of 101 Growth Path can manage and present learning milestone of the user, which is related to learning progress the user has made after a period of time, and can encourage the user, or exert pressure on the user, thereby produce the effect of promoting user learning.

As an example, the 101 Growth Path can be set to such a set of growth levels: freshmen, old student, representative of lesson, commissary in charge of studies, assistant class monitor, class monitor, etc. This kind of milestones of growth path can be used for students in China. In other countries, there are maybe big differences.

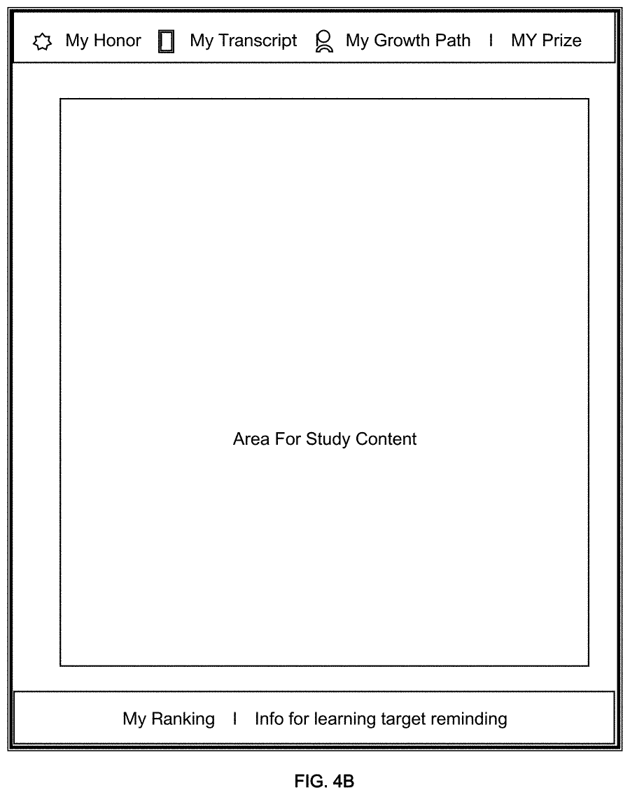

To attract users, the corresponding cartoon image can be used to represented the character at each levels, as shown in FIGS. 5A,B, which show example cartoon image of girls and boys respectively.

In FIG. 6, the level or milestone of growth Path of the example educational game software, I Am Li Bai, is set at the lowest milestone, that is, freshman. And the thumbnail of freshman cartoon image is shown in interface component 601, i.e. the area of Character Image for My Growth Path.

As to the design, the embodiment of 101 Growth Path must be linked to the user identity and/or environment, such as students in elementary school, middle school or high school, and so on.

In practical applications, there is a User Authentication and Profile Manage module where user's information about age, gender, grade, first language, learning target, choice of learning content, etc. can be entered and saved. Based on these information, educational game software can analyze and provide one or more type of images of growth path to choose.

Based on learning content, user preferences and user background, the ‘paths’ used by Growth Path Method/system can be mainly divided into five types, comprising: position series; wealth level series; fame level series; academic level series; grade level series. Wherein, the position series can be government official positions, such as Secretary of Labor, Secretary of Commerce, Secretary of Agriculture, Secretary of the Interior, Attorney General, Secretary of Defense, Secretary of the Treasury, Secretary of State, Speaker of the House of Representatives, President of the Senate, Vice President, President; police duties, such as Officer, Detective, Sergeant, Lieutenant, Captain, Deputy Inspector, Inspector, Deputy Chief, Assistant Chief, Bureau Chief, Chief of Department; military duties, such as Ensign, Lieutenant, Captain, Major, Lieutenant Colonel, Colonel, Brigadier, Major General, Lieutenant General, General, Five-Star General; medical system position; education system position, and so on.

Wherein, the wealth level series can be Poor Farmer, Rich Farmer, Landlord, Millionaire, Multi-millionaire, Billionaire, and so on.

Wherein, the fame level series can be Newcomer, Person with Good Performance, Person with Excellent Performance, Person with A Certain Reputation, Person with A Good Reputation, Person with A Wide Reputation, More Famous People, Very Famous Person, Respected Person, Very Respected Person, Celebrity, and so on.

Wherein, the academic level series can be Newcomer, Potential Person, Person with Certain Ability, Person with Strong Ability, Person with Strong Ability, Person with Good Academic Achievements, Person with High Academic Achievements, Very Talented Person, and so on.

Wherein, the grade level series can be Preschool Student, PK Student, Kindergarten Student, First Grader, Second Grader, Junior High School First Grade, First Year High School Student, etc.

The determination of growth level in the embodiment of 101 Growth Path can synthetically based on one user's own learning status, and level threshold set by default by the system or the comparison of learning score between members of study group that using the same educational software and exchanging learning status information between members.

Wherein, for the case where the growth level threshold is set by default by the system, the determination of growth level is calculated by the same standard, which means the same learning score corresponds to the same growth level. This is the most common way which can be used by any one user, and the determination of growth level of one user has nothing to do with other users. This is suitable for evaluating user's own learning status.

Wherein, for the case where the determination of growth level is define by the comparison of learning score between members of study group, one use's growth level relates to the performance of others. For example, if the software′ setting is there is only one monitor in a group, the highest growth level in a learning group, then only the user who achieves the highest score can get this growth level. Designing like this can introduce valuable competition among a group.

### Learning Role Models

The function of 102 Learning Role Models can manage and present user-acquired role model corresponding to learning level.

In the example software, I Am Li Bai, it includes thirteen famous Chinese ancient poets, such as Ma Zhiyuan, He Zhizhang, and finally Li Bai, whose famous degree is from low to high. When users improve their learning level step by step, they can get the power to find and get more and more famous poet as their role model.

In FIG. 6, the role mode of the example educational game software, I Am Li Bai, is set with the first poet, Ma Zhiyuan, whose Chinese ink style portrait is shown in interface component 602, i.e. the area of My Model Picture.

In China, there is a famous sentence, a good example has boundless power, the same meaning as that if one sheep leaps over the ditch, all the rest will follow. With the role mode in mind, users may be more willing to learn more about the role model, thus facilitating users to consciously study and expand knowledge.

These chosen role model should be widely well-know and admitted persons who students can know relevant information from their parent, teachers, classmates, textbooks, etc. And owning the ability of acquiring higher level role model in educational game software would be enviable and respectful, thereby promoting beneficial competition among classmates or friends.

The method to determine which role model should be awarded to user is set by the educational software by default, meaning that the exact role model achieved by user is corresponding to the result of comparison between learning achievement/status and threshold set by software.

In practical applications, there is a User Authentication and Profile Manage module where user's information about age, gender, grade, first language, learning target, choice of learning content, etc. can be entered and saved. Based on these information, Educational game software can analyze and provide one or more type of character images of learning role models to choose.

Based on learning content, user preferences and user background, the role models of the Learning Role Models method/system can be mainly divided into four types, comprising: outstanding historical figure series; virtual idol series; realistic star idol series; excellent student or classmate series.

Wherein, the outstanding historical figure series can be famous ancient poets, as In the example software, I Am Li Bai, the set of character images includes several famous ancient poets, such as Ma Zhiyuan, He Zhizhang, Li Bai, and so on; great mathematician in history, such as Gauss, Newton, Archimedes, Euler, Cauchy, and so on.

Wherein, the virtual idol series can be characters in popular cartoon, science fiction movies, etc.

Wherein, the realistic star idol series can be popular astronauts, popular winners of pop music competition, movie stars, and so on.

Wherein, the excellent student or classmate series can students with good moral character and excellent academic performance.

### My Prize

The function of 103 My Prize can manage and present user-acquired prize corresponding to learning level.

The prize can be set by parent, teachers or sponsors, and may be virtual mostly, but may be in correspondence with real thing that will be provided by parent, teachers or sponsors.

In practical applications, there is a User Authentication and Profile Manage module where user's information about age, gender, grade, first language, learning target, choice of learning content, etc. can be entered and saved. Based on these information, Educational game software can analyze and provide one or more type of prizes images of My Prize to choose.

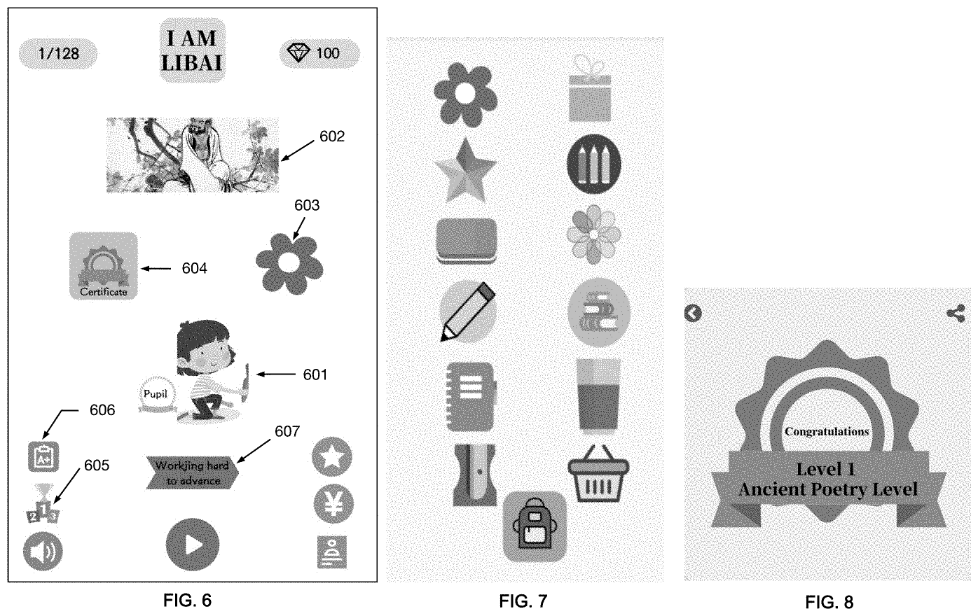

In the example software, I Am Li Bai, the set of character images includes small red flower, eraser, pencil, pencil case, water cup, lunch box, school bag, vacuum flask, etc. as shown in FIG. 7, what are more suitable for younger students in elementary school. And in FIG. 6, a thumbnail of a prize picture, a small red flower is shown in the interface component 603, i.e. the area of My Prize.

Parent, teacher, or others with administrative authority, can change the rewards choice basing on comprehensive understanding of user's learning status and need for motivational effects.

Based on learning content, user preferences and user background, the prizes of the My Prize method/system can be mainly divided into eight types, comprising: decoration series; school supplies series; household products and daily necessities series; things related to reverie series; real estate related series; traffic related series; attractions tickets related series; real thing series.

Wherein, the decoration series can be children's favorite posters, decorative paintings, and so on. Wherein, the school supplies series can be bag, pencil box, basketball, and so on. Wherein, the household products and daily necessities series can be plates, TV, refrigerator, and so on. Wherein, the things related to reverie series can be dream careers, magic, places to dream of exploring, and so on. Wherein, the real estate related series can be various types of houses, villas, castles, and so on. Wherein, the traffic related series can be various popular cars, trains, planes, and so on. Wherein, the attractions tickets related series can be tourist attraction tickets, famous museum tickets, and so on. Wherein, the real thing series include things that should be really provided to users, such as toys, school supplies, prize vouchers, coupons, and so on.

### My Honor

The function of 104 My Honor can manage and present user-acquired honor corresponding to learning level.

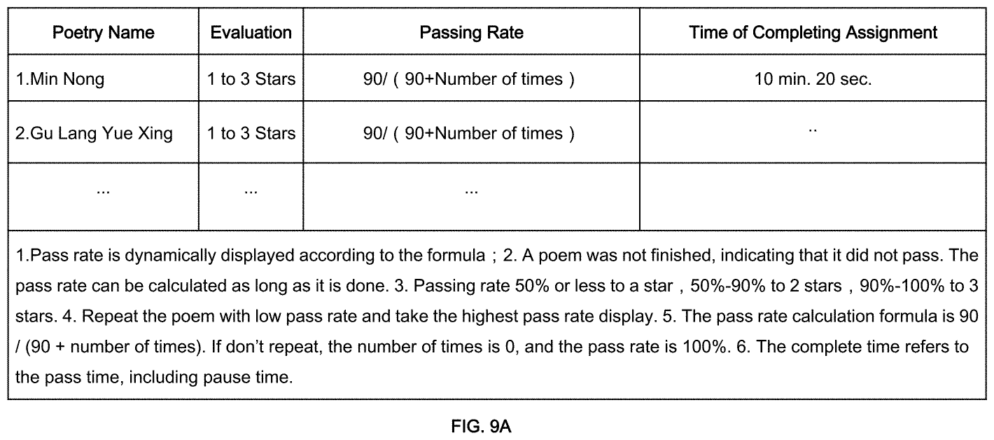

As shown in FIG. 8, it is a certificate picture of the first grade Chinese ancient poetry, used in the example educational App, I Am Li Bai. And in FIG. 6, a thumbnail of this picture is shown in the interface component 604, i.e. the area of My Honor.

There are two methods to determine which certificate should be awarded to user. The first one is comparing the learning status to threshold set by software. For example, the threshold is corresponding to syllabus, and the certificates can be primary school first grade ancient poetry level, primary school second grade ancient poetry level, etc. as shown in FIG. 8, which is an certificate picture of the example educational game software. The second one is setting the game rules and style of certificate by user, wherein certificates can be designed, selected, and uploaded into the software by user. The second method may be more suitable for organizing competition activity. And, normally, only persons with administrative rights can set the rule, e.g. parents, teachers, event organizer.

Based on learning content, user preferences and user background, the honors of the My Honor method/system can be mainly divided into three types, comprising: certificate series; badge series; cup series.

Wherein, the certificate series can be certificates of achievement, competition certificate.

Wherein, the badge series can be competition medal, commemorative medal. Wherein, the cup series can be competition trophies, etc.

### My Transcript

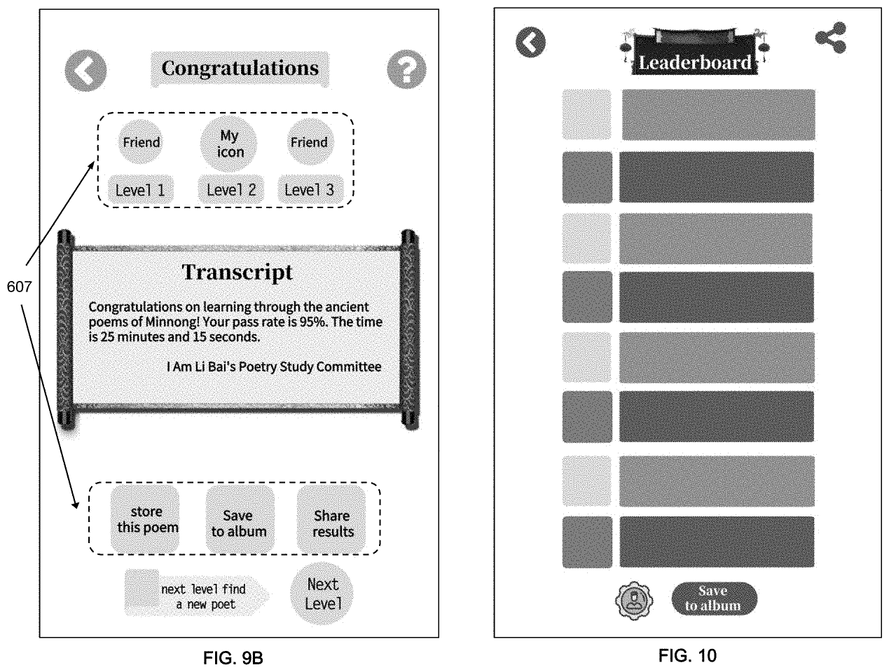

The 105 My Transcript can organize, analyze, display details of the user's answer to each question, including correct answer rate, the number of correct answers and the time required for correct answer, etc. and provide the information of comprehensive academic performance in current learning phase. And information can be shown in attractive way, such as a beautified transcript.

Wherein, both statistical achievement data and incentive-related information, including friends' progress, etc., can be provided in transcript, as shown in FIGS. 9A,B in example software, I Am Li Bai. In FIG. 9A, there is a statistic data table, showing poetry name, evaluation, passing rate, and time for completing the assignment as to each poem. In FIG. 9B, there is a graphical interface of a transcript, the information presented including poetry name, evaluation, passing rate, time for completing the assignment, learning status of two friends. This transcript can saved and shared. And in FIG. 6, the main interface, there is an interface component 605, which maybe a function button or function menu. After users click or select it, the transcript interface would be shown.

The data used in 105 My Transcript are important, basic information about user's learning status, and are used by every incentive functions of educational software in order to determining learning level.

Most importantly, the data can be used by the user, parent, teacher, etc. to analyze learning status in details. For example, based on large quantity of accumulated information about user background, learning status, big data analysis technology and methods, learning status, improvement suggestion for a specific type of users or a specific user may be obtained.

### My Ranking

Based on users' learning level, the 106 My Ranking can manage and present user's ranking in different range, such as friend group, all users.

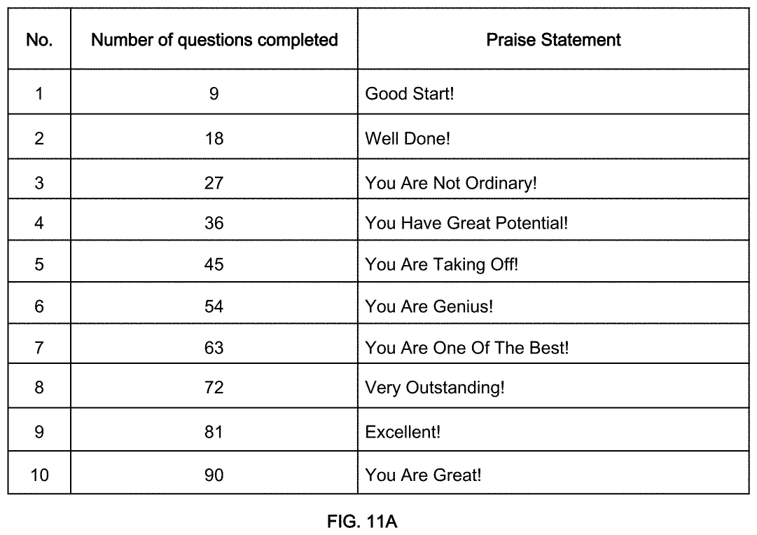

An example of My Ranking software interface of the software, I Am Li Bai, is shown in FIG. 10. And in FIG. 6, the main interface, there is an interface component 606, which maybe a function button or function menu. After users click or select it, the ranking interface would be shown.

Ranking are competitive in nature, and ranking results can stimulate some people's interest in learning, but may also hurt some people. To reduce the negative impact of ranking, and better encourage users to learn, there are at least two way to do. Firstly, the ranking range can be selectable, e.g. in all users, in friends group, or by themselves. Secondly, the ranking perspective can be diverse, e.g. comprehensive ranking, and sub-item ranking, which may be based on average learning time, average time taken to reach the corresponding level, or average pass rate, etc. Multi-dimensional ranking can present learning status more realistically and comprehensively, and show different advantage of different users.

### Personal Learning Target Reminding Methods and Systems

Reminding is a useful method for study by providing suitable praise, encouragement, pressure on users. Research shows that allowing users to keep abreast of learning progress and achievements can stimulate users' motivation and interesting in study, and allowing users to keep abreast of the gap between learning situation and goals, and the gap between themselves and others, can create pressure to motivate users to change learning methods and plans to improve learning outcomes.

This invention include two personal learning target reminding methods/systems, comprising 201 Learning Goal Prompt, 202 Learning Ranking Reminder, as shown in FIG. 2. These personal learning target reminding methods/systems can be implemented in mobile educational game individually or jointly.

As shown in FIG. 6 and FIG. 9B, the information of learning goal and learning ranking are shown in interface component 607.

### Learning Goal Prompt

The method/system of Learning Goal Prompt can show information, including how many steps are needed to pass to level up, who is the next poet model, what is the next awards, certificates, etc. on several software interfaces. Such would prompt users in a timely and effective manner.

### Learning Ranking Reminder

The method of Learning Ranking Reminder can show the information about ranking gap between themselves and friends on several software interfaces to prompt users in a timely and effective manner.

### Training Process Positive Encouragement Methods and Systems

Responsible urging, honest encouragement from teachers, parents, team members, and so on, play an import role in one's study. Many researches and experiences have proved that continuous and positive encouragement in learning process play a great role in study. This is the basis for Training Process Positive Encouragement methods and systems, the third major part of this invention.

This invention include two training process positive encouragement methods/systems, comprising 301 Adding Points for Answering Question Correctly, 302 Sound Effects, Pictures, Colorful Presentation for Answering Question Correctly.

Compared with six results feedback excitation methods/systems, 101 to 106, the two positive encouragement are implemented in the process of practicing or testing, where users might lose focus, interest, or confidence, little by little.

### Adding Points for Answering Question Correctly

It is easy to understand that the feature of Adding Points for Answering Question Correctly is adding one or more points if user answers one question correctly.

### Sound Effects, Pictures, Colorful Presentation for Answering Question Correctly

The feature of Sound Effects, Pictures, Colorful Presentation for Answering Question Correctly is presenting encouraging words, pictures, colorful effect, etc. when users are in practicing or testing.

Wherein, the sound effects include button sound effect, feedback sound effect and achievement sound effects, etc.

The design of sound effect integrate the following points, including: the music can be configured, the sound effect should be consistent with scene, overall design style should keep consistent, the right time to present sound effect should be reasonable, the sound effect should be adjusted according to the scene, and the overall style should be mainly based on simplicity.

In practical applications, there is a User Authentication and Profile Manage module where user's information about age, gender, grade, first language, learning target, choice of learning content, etc. can be entered and saved. Based on these information, educational game software can analyze and provide one or more type of sound effects, pictures, colorful presentation.

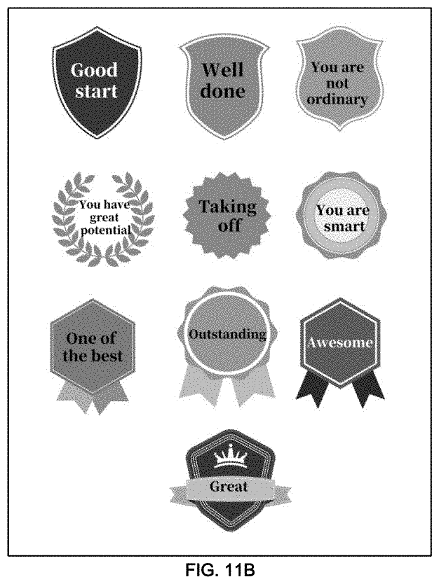

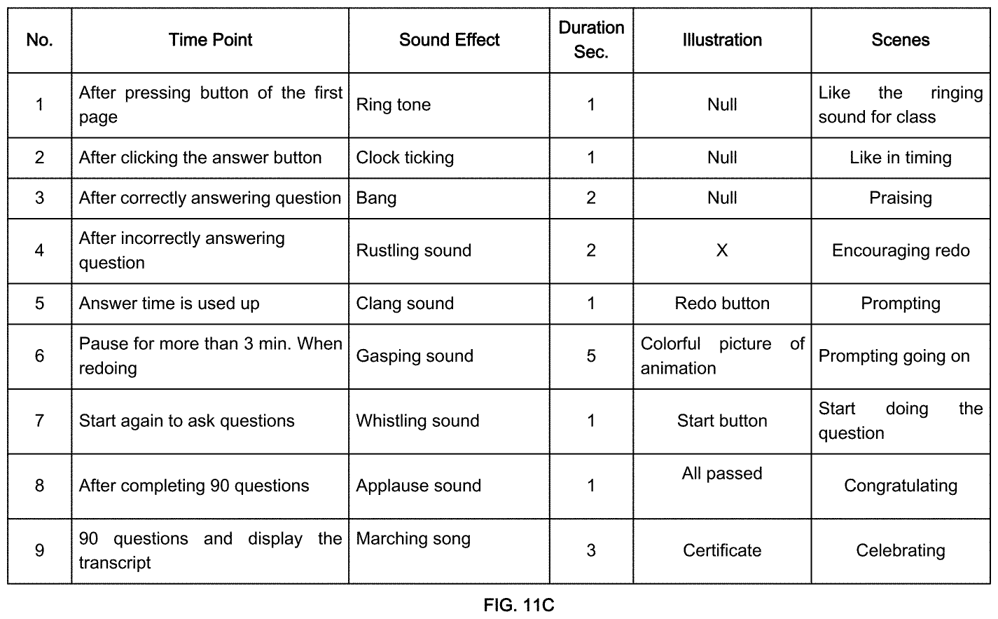

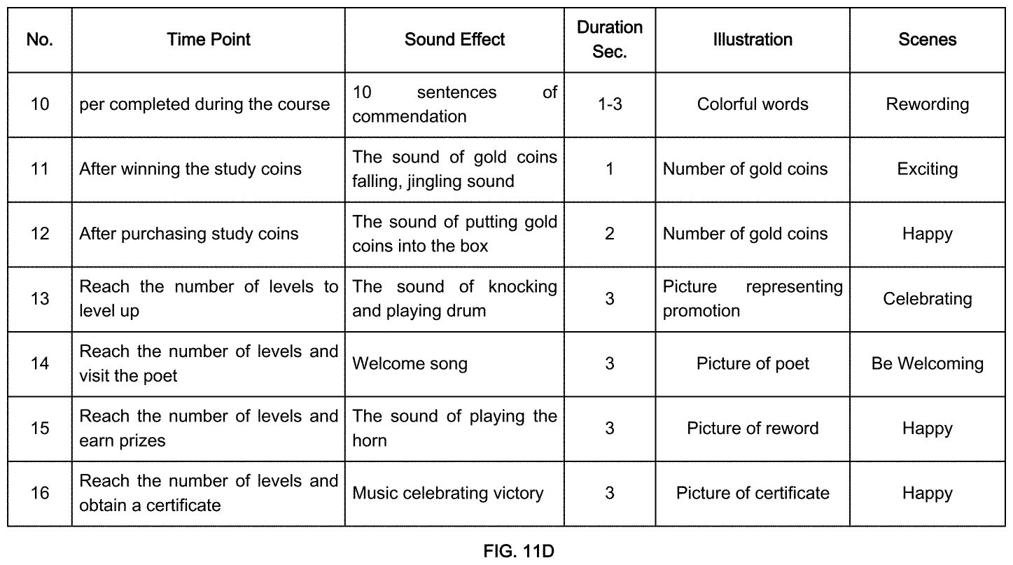

FIG. 11A-C show table and software interface of the example educational game software, which is used in the embodiment of Sound Effects, Pictures, Colorful Presentation method/system of this invention.

Wherein, the FIG. 11A shows a table of the reward statement corresponding to each set of nine questions answered. For example, after a user correctly answers the first set of nine questions, the app will play a voice saying ‘Good start!’; after a user correctly answers the second set of nine questions, the app will play a voice saying ‘Well done!’ Wherein the FIG. 11B shows a set of pictures. When a user correctly answer some questions, one of the pictures will be presented on the screen.

Wherein the FIG. 11C-D shows the sound effect, illustrations, scenes corresponding to time point, when a user performs some kinds of software operation. For example, after a user presses the start button of the first page of app, the app will play a piece of music like the ringing sound for class; after a user correctly finishes 90 questions, then a transcript will be displayed, a piece of music like marching song be played, a certificate be shown.

Although the use of Sound Effects, Pictures, Colorful Presentation for Answering Question Correctly method could be effective to most users, to provide more flexibility, the embodiment of the invention software could allow users to “turn on/off” this incentives to their liking.

### Achievement Sharing and Showing Method/System

The forth major part of this invention include 401 Achievement Sharing and Showing method/system. With 401 Achievement Sharing and Showing, Users can share their honor, certificates, badges, prizes, thus inspire a sense of honor to individuals, and form a benign competition in groups. Furthermore, the 401 Achievement Sharing and Showing can promote the sharing of learning experience and methods, which is more valuable for improving individual, even group learning.

As shown in FIG. 1, there is a data server, in which all users' study honor, certificates, badges, prizes information is stored. These information can be set to be visible to all users, or a specified group.

As a possible application, competition can be organized between individuals, or groups. And teamwork, involved in the process of striving for victory, can spread good learning experience, and stimulate the enthusiasm, interest of learning.

As to sharing method, the embodiment of this invention can embed dedicated instant messaging function, and/or establish links with popular messaging software, such as email, Messages, etc. This can give user more choices.

By 401 Achievement Sharing and Showing, users can give their own prize to friends, which would facilitate communication between study group member, such is helpful to motivate study.

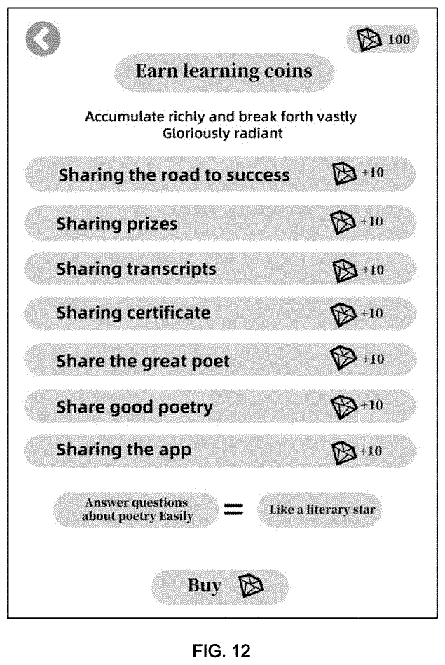

FIG. 12 is the interface of the example educational app, I Am Li Bai, which is used in an the Achievement Sharing and Showing embodiment of the Achievement Sharing and Showing of this invention. In this interface, users can share growth path, prize, transcript, certificate, model, poem, etc.

Although the use of 401 Achievement Sharing and Showing could be effective to most users, to provide more flexibility, the embodiment of the invention could allow users to “turn on/off” this function to their liking.

### Learning Achievement Saving and Printing Method/System

The fifth major part of this invention include 501 Learning Achievement Saving and Printing method/system. Through this method/system, users can record, save every achievement of studying, export achievement information that, for example, can be used in a competition and/or commendation activity.

The achievement can be printed either in paper form directly or in electronic file form, and both ways have their own uses and benefits. The paper form may be more suitable to younger kids who are limited in accessing mobile devices. The electronic file form is easier for transferring or sharing.

1. A set of methods and systems that can be used in the design of educational game software running on mobile devices, such as mobile phone.

2. The methods and systems of claim 1, wherein the set of methods and systems for mobile learning game software, comprising: six results feedback excitation methods/systems; two personal target reminding methods/systems; two training process positive encouragement methods/systems, one learning achievement sharing and showing method/system; one saving and printing method/system. Every method is a kind of software design idea, and simultaneously is a kind of software system with a specific function.

3. The methods and systems of claim 2, can be implemented in mobile educational game individually or jointly, but using jointly is the core of achieving the best incentive effect. The way of using jointly could be that involving multiple and diverse information related to these above methods/systems as reasonably as possible on the main software interface, and other software function interfaces.

4. The methods and systems of claim 2, wherein the six results feedback excitation include Growth Path, Learning Role Models, My Prize, My Honor, My Transcript, My Ranking methods/systems. These six external incentives methods and systems are closely related to internal incentives, including the inner expectations and sense of honor of academic progress. The functions of the six results feedback excitation methods/systems are as following:
The Growth Path method/system can manage and present learning milestone of the user, which is related to learning progress the user has made after a period of time, and can encourage the user, or exert pressure on the user, thereby produce the effect of promoting user learning. Wherein The Growth Path must be linked to the user identity and/or environment. Wherein the level determination in Growth Path is synthetically based one user's own learning status, level threshold set in the system, the comparison of achievements between members of study group that using the same educational software and exchanging learning status information;
The Learning Role Models method/system can manage and preset role models corresponding to learning content and user background, as a ‘reward’ based on user's learning status, and when users improve their learning level step by step, they can find and get more and more famous people as their role model;
The My Prize method/system can manage and present user-acquired prize corresponding to learning level;
The My Honor can manage and present user-acquired honor corresponding to learning level;
The My Transcript method/system can organize, analyze and display details of the user's answer to each question, including correct answer rate, the number of correct answers and the time required for correct answer, etc. and provide the information of comprehensive academic performance in current learning phase;
The My Ranking can manage and present user's ranking in different range, such as friend group, all users, and apply Multi-dimensional statistical analysis method that can demonstrate the different advantages of different users, reduce the negative impact of ranking.

5. The methods and systems of claim 4, wherein the six results feedback excitation methods and system should be used in educational game software integrated, and the six factor corresponding to the six results feedback excitation methods and systems should be involved in the main software interface design in order to maximize the effect of incentives.

6. The methods and systems of claim 4, wherein the ‘paths’ of the Growth Path Method/system can be mainly divided into five types, comprising: position series, such as official position; wealth level series; fame level series; academic level series; grade level series.

7. The methods and systems of claim 4, wherein the role models of the Learning Role Models method/system can be mainly divided into four types, comprising: outstanding historical figure series; virtual idol series; realistic star idol series; excellent student or classmate series.

8. The methods and systems of claim 4, wherein the prizes of the My Prize method/system can be mainly divided into eight types, comprising decoration series; school supplies series; household products and daily necessities series; things related to reverie series; real estate related series; traffic related series; attractions tickets related series; real thing series.

9. The methods and systems of claim 4, wherein the honors of the My Honor method/system can be mainly divided into three types, comprising certificate series; badge series; cup series.

10. The methods and systems of claim 2, wherein two personal target reminding methods/systems include Learning Goal Prompt, Learning Ranking Reminder methods and systems, which allow users to keep abreast of learning progress and achievements in a timely and effective manner, thus stimulate users' motivation and interesting in study.

11. The methods and systems of claim 2, wherein two training process positive encouragement methods/systems include Adding Points for Answering Question Correctly; Sound Effects, Pictures, Colorful Presentation for Answering Question Correctly methods and systems, which can be implemented in process where users might lose focus a bit and bit on learning. The features of Sound Effects, Pictures, Colorful Presentation for Answering Question Correctly can present encouraging words, pictures, colorful effect, etc. wherein, the sound effects include button sound effect, feedback sound effect, feedback sound effect and achievement sound effects, etc. Wherein the design of sound effect integrate the following points, including: the music can be configured, the sound effect should be consistent with scene, overall design style should keep consistent, the right time to present sound effect should be reasonable, the sound effect should be adjusted according to the scene, and the overall style should be mainly based on simplicity.

12. The methods and systems of claim 2, wherein one learning achievement sharing and showing method/system is a method, and simultaneously a kind of software system with a specific function, by which Users can share their honors and other incentives, thus inspire a sense of honor to individuals, and form a benign competition in groups.

13. The methods and systems of claim 2, wherein one saving and printing method/system is a method, and simultaneously is a kind of software with a specific function, which export achievement information that, for example, can be used in a competition and/or commendation activity.

14. The methods and systems of claim 1, the naming forms of every method/system of the embodiment of the invention can be adjusted as needed.
